(19) United States
(12) Patent Application Publication
(10) Pub. No.: US 2026/0300444 A1
(43) Pub. Date: Oct. 1, 2026

(54) INDIVIDUAL IDENTITY AUTHENICATION

(71) Applicant: Lenovo Global Technology (United States) Inc., Morrisville, NC (US)

(72) Inventors: Robert James Norton, JR., Raleigh, NC (US); Scott Li, Cary, NC (US); Robert J. Kapinos, Durham, NC (US); Igor Stolbikov, Apex, NC (US)

(21) Appl. No.: 19/094,238

(22) Filed: Mar. 28, 2025

(51) Int. Cl. G06F 21/10

(52) U.S. Cl. CPC G06F 21/1015

(57) ABSTRACT

One embodiment provides a method, the method including: receiving, at an identity verification system, a corpus of content corresponding to an individual, wherein the corpus of content is indicative of authorship characteristics of the individual; creating, using the identity verification system, an individual artificial intelligence model that is trained using the corpus of content and that is configured to be used to verify authorship of secondary content that is separate from the corpus and purported as being authored by the individual; and determining, using the individual artificial intelligence model, whether a received secondary content is authentic with respect to the individual. Other aspects are claimed and described.

### BACKGROUND

With the increase in digital footprints for individuals (e.g., social media accounts, online papers authored by individuals, online images and videos of individuals, etc.), the presence of individuals in online content has also increased. Even individuals who do not have an online presence maintained by the individual, may still have an online presence. For example, other individuals may include that individual in images posted to a social media account. As another example, papers authored or co-authored by an individual for an entity may be presented online by the entity. For those individuals who have a purposeful online presence, the amount of online content related to the individual can be large. Additionally, for those individuals who are famous or who a community may have a fascination, the amount of online content that is purported to be of the individual may be extremely large.

### BRIEF SUMMARY

In summary, one aspect provides a method, the method including: receiving, at an identity verification system, a corpus of content corresponding to an individual, wherein the corpus of content is indicative of authorship characteristics of the individual; creating, using the identity verification system, an individual artificial intelligence model that is trained using the corpus of content and that is configured to be used to verify authorship of secondary content that is separate from the corpus and purported as being authored by the individual; and determining, using the individual artificial intelligence model, whether a received secondary content is authentic with respect to the individual.

Another aspect provides a system, the system including: a processor; a memory device that stores instructions that, when executed by the processor, causes the system to: receive, at an identity verification system, a corpus of content corresponding to an individual, wherein the corpus of content is indicative of authorship characteristics of the individual; create, using the identity verification system, an individual artificial intelligence model that is trained using the corpus of content and that is configured to be used to verify authorship of secondary content that is separate from the corpus and purported as being authored by the individual; and determine, using the individual artificial intelligence model, whether a received secondary content is authentic with respect to the individual.

A further aspect provides a product, the product including: a computer-readable storage device that stores executable code that, when executed by a processor, causes the product to: receive, at an identity verification system, a corpus of content corresponding to an individual, wherein the corpus of content is indicative of authorship characteristics of the individual; create, using the identity verification system, an individual artificial intelligence model that is trained using the corpus of content and that is configured to be used to verify authorship of secondary content that is separate from the corpus and purported as being authored by the individual; and determine, using the individual artificial intelligence model, whether a received secondary content is authentic with respect to the individual.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for determining if a received secondary content is authentic with respect to an individual using an individual artificial intelligence model that is trained on content corresponding to the individual.

### DETAILED DESCRIPTION

With the increase in not only the ability to create online content, but also the increase in accessibility of software, programs, and algorithms that can be utilized to modify content, content that is purported to be of or related to an individual is increasing, even when that content is not actually of that individual. Additionally, the software that is used to modify content to make it appear to be of an individual is becoming better and better, which is making it more difficult to discern whether content is really from that individual. For example, a person could modify an audio file to make it sound like it is being spoken by one individual, when in fact, that individual did not actually say or make the audio content. This phenomenon related to creating content that is purportedly from an individual is commonly referred to as a deepfake, particularly when the fake content is made using artificial intelligence.

Deepfakes can manipulate audio, video, photos, and/or the like, in order to make it appear real. Deepfakes can replace faces of individuals with a desired individual, can manipulate facial expressions, can synthesize speech, and/or the like. As the artificial intelligence models get better, the deepfakes get better. For example, in earlier deepfakes, artefacts, particularly in videos, were evident which made it easier to determine that the content was artificially created. However, more recent deepfakes may not have as many or as obvious artefacts. Thus, to determine whether the content is fake may take more time and more analysis to look for such artefacts. Accordingly, the deepfakes have reached a level of believability such that the general population will believe that it was actually created by the individual. Additionally, in some cases, parts of the population want to believe that it was created by the individual in order to align with the desired narrative.

Additionally, another problem with online content is that some content is assumed to be real based upon the source of the content. For example, if an individual has a social media account that is known to belong to that individual, it is assumed that content posted to that account is either being posted by the individual themselves or by someone authorized by the individual. The problem is that such accounts can be hacked or taken over by other entities or individuals. Thus, the posted content may not actually be content posted by the individual, but instead may be content posted by the hacker or other entity that has taken over the account. With some individuals claiming the account was hacked when it was not actually hacked, it is hard to discern whether the content was actually posted by the individual.

Currently, individuals have to make statements regarding an authenticity of online content. However, by the time an individual is made aware of online content that needs a statement, the content is already likely causing issues for the individual. Additionally, people may choose to believe that online content is real even if an individual has indicated it is not in fact real, since it is sometimes in the interest of the individual to discredit content even if it is actually real. Sometimes individuals can add watermarks to online content to assist in identifying real content. However, this is time consuming, is not likely to be useful for all online content, and can also be faked itself. Therefore, this solution is likely not particularly effective.

Accordingly, the described system and method provides a technique for determining if a received secondary content is authentic with respect to an individual using an individual artificial intelligence model that is trained on content corresponding to the individual. The identity verification system receives a corpus of content indicative of authorship characteristics of the individual or corresponding to an individual. The content may include or correspond to the individual and characteristics of the individual. For example, the content may be content which corresponds to a speaking style of the individual, mannerisms of the individual, a mood of the individual, a writing style of the individual, body language of the individual, and/or the like. The content that is received is content that is specifically chosen by the individual, or an authorized person of the individual. This content may be personal to the individual and may be content that is not accessible to other individuals or entities. The content may include documents, videos, images, social media posts, emails, and/or the like.

Using the content, the identity verification system creates an individual artificial intelligence model. This model is trained using the corpus of content (“content”) and can then be used to verify whether secondary content that is purported as being of the individual is actually of the individual. In other words, the system creates an individual AI model that can be used to validate or authenticate secondary content to determine if it is fake or real content with respect to the individual. Accordingly, the individual AI model can determine whether a received secondary content is authentic with respect to the individual. The received secondary content may be content that is used within an authentication query to the individual AI model. Alternatively, or additionally, the individual AI model can mine secondary content and determine an authenticity of that secondary content.

Therefore, a system provides a technical improvement over traditional methods for individual identity authentication. The described system provides a technical improvement to the computer technology field. The generation and proliferation of online content and, specifically, fake online content is specifically a computer problem. The advent of online content and ability to create content utilizing different software, programs, and algorithms, has created the issue of people being able to create content that is purported to be coming from a particular individual or depicting that particular individual. With this increase in fake content, it has become a serious problem for individuals to attempt to monitor and authenticate content. Thus, the described system allows for a technique to utilize the same technology that has created the problem to help solve the problem.

Instead of people having to monitor online content and make statements regarding the authenticity of the content, the described identity verification system can perform this validation and authentication instead. Since the identity verification system has access to content that is validated by the individual, the identity verification system can validate whether content that is purported to be of an individual is actually of that individual. Thus, the described system provides a significant technological improvement to individual identity authentication and solves a necessarily computer problem.

The illustrated example embodiments will be best understood by reference to the figures. The following description is intended only by way of example, and simply illustrates certain example embodiments.

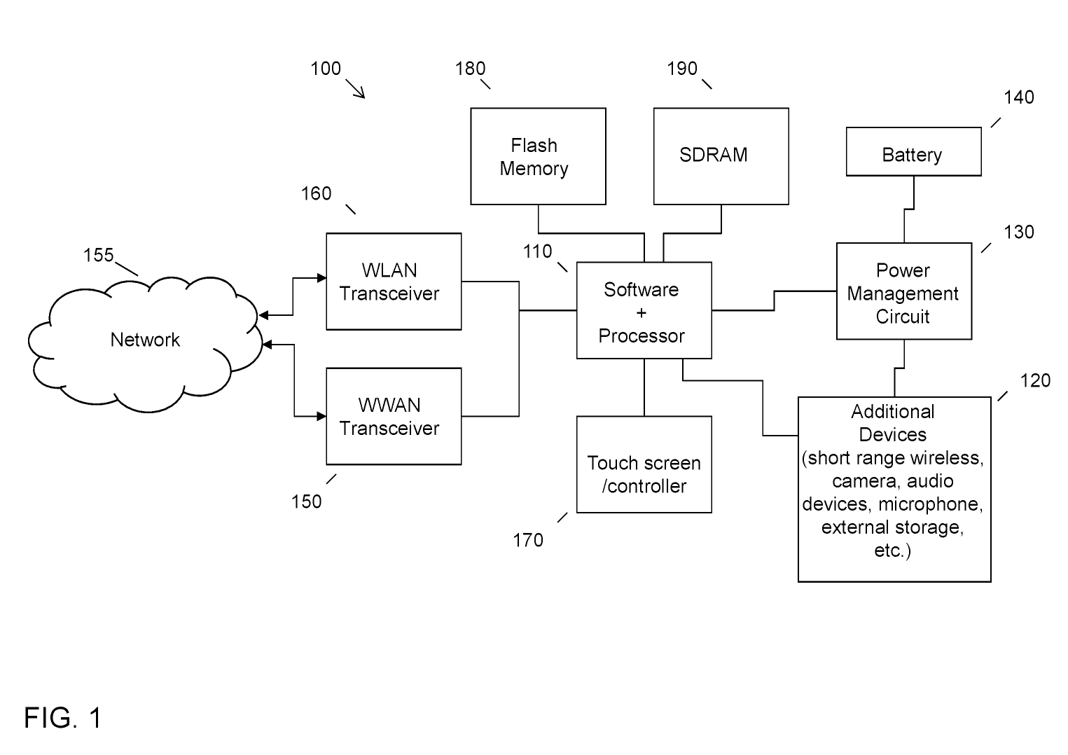

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

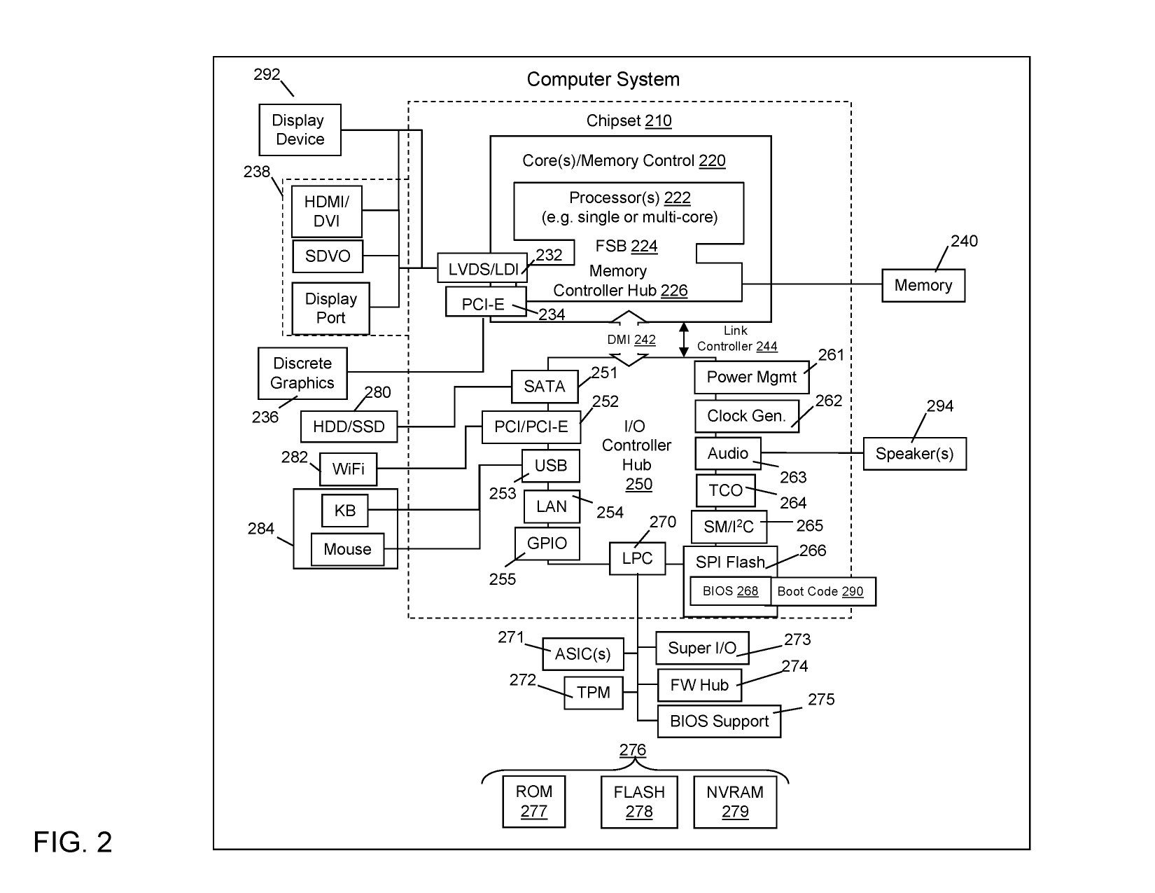

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIGS. 1 and 2, may be used in devices such as tablets, smart phones, personal computer devices generally, and/or electronic devices, which may be devices that are used in or to access the identity verification system, that house or provide access to the identity verification system, and/or the like. For example, the circuitry outlined in FIG. 1 may be implemented in a tablet or smart phone embodiment, whereas the circuitry outlined in FIG. 2 may be implemented in a personal computer embodiment.

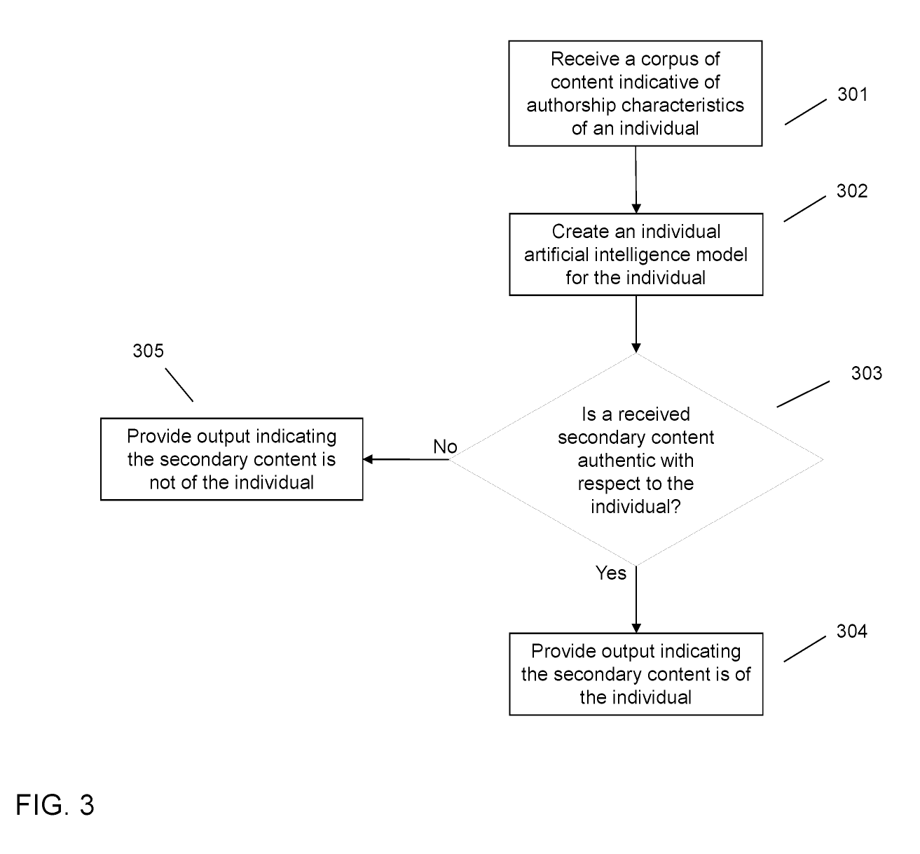

FIG. 3 illustrates an example method for determining if a received secondary content is authentic with respect to an individual using an individual artificial intelligence model that is trained on content corresponding to the individual. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIGS. 1 and/or 2. While the system may include known hardware and software components and/or hardware and software components developed in the future, the system itself is specifically programmed to perform the functions as described herein to validate information against a personal artificial intelligence model. Additionally, the identity verification system includes modules and features that are unique to the described system.

The identity verification system may be activated in order to authenticate secondary content that is purported to be of an individual. This content may be purported to depict the individual, be content purportedly created by the individual, and/or the like. The system includes a trained individual artificial intelligence model that is trained using content that is either known to be of the individual or may be content that is known to not be of the individual. Thus, the individual AI model is specific to the individual and is specifically created to be able to authenticate content with respect to the individual. Accordingly, the identity verification system may be activated when the individual wants secondary content authenticated, when other individuals want to authenticate content, and/or the like.

Activation of the identity verification system may be a manual activation of the identity verification system and/or an automatic activation of the identity verification system. Manual activation of the system may include a user opening an application associated with the identity verification system, the user accessing the computing system associated with the identity verification system, and/or the user otherwise providing input to the identity verification system. The automatic activation of the identity verification system may be based upon the detection of a trigger event indicating that the system should be activated. Example trigger events include the detection of secondary content purportedly of the individual, detection of content being added to a source the system is set to monitor, a user accessing an application that interfaces with the identity verification system, activation of software or an application utilizing the identity verification system, and/or the like.

The identity verification system may be made of multiple systems or modules that communicate together to make up the identity verification system or may be a single system. The identity verification system may be a standalone system, may be accessible through other computing devices, and/or a combination thereof. For example, the identity verification system may be a standalone system that can be accessed by a user and/or may be or provide an application that is accessible by a user on another computing device. The identity verification system may be accessible using any type of computing device, for example, personal computer, laptop computer, smartphone, tablet, smartwatch, head-mounted display, smart television or other smart appliance, augmented reality device, virtual reality device, and/or the like.

Thus, the identity verification system may be accessible locally using a computing device where the identity verification system is installed and/or may be accessible remotely through another computing device. For example, the identity verification system may be accessed by a user using a device that communicates with the identity verification system to authenticate content with respect to an individual, and/or the like. However, the identity verification system may be located and operate on a different information handling device to perform the described steps. In other words, the user may access a device housing the identity verification system or may access a device that communicates with a device housing the identity verification system.

The identity verification system can be provided as a service to other entities, companies, or individuals. In other words, the identity verification system could be stored on a server or network of a company and the system can include unique individual AI models that are trained for particular individuals. The system can then perform the authentication of content using those individual AI models and provides outputs related to the authentication.

The identity verification system may have an associated graphical user interface. The graphical user interface may be provided on a display or monitor, which may or may not be associated with the identity verification system. In other words, the identity verification system may have a dedicated display or monitor or may be accessible using any display or monitor. In either case, the identity verification system may provide instructions to generate and display the graphical user interface on the display device being used to access the identity verification system. The graphical user interface may also be updated and managed based upon instructions provided by the identity verification system. In other words, the identity verification system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the identity verification system. For example, the identity verification system may utilize a user profile, historical information, and/or the like, to create and update an individual artificial intelligence model, determine whether a received secondary content is authentic, and/or the like. The graphical user interface may allow for creation of or access to these profiles, historical information, and/or the like, by allowing a user to input information regarding user preferences, individual content, and/or the like. As will be discussed in more detail, the use of user provided information is not the only way that the profile and/or historical information can be created. The identity verification system can then utilize these inputs, whether provided directly by the user or identified using a different technique, to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, gaze input, electromyography input, virtual or augmented reality input, and/or the like.

The graphical user interface may also provide displays that display information of the profiles, and/or the like. It should be noted that the information to be used by the identity verification system and information provided by the identity verification system can be different for different applications, different computing systems, different users, and/or the like. Thus, the information corresponding to input or output of the identity verification system are not always the same. However, the identity verification system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The identity verification system may utilize one or more artificial intelligence models in determining whether a received secondary content is authentic with respect to an individual. In other words, one or more artificial intelligence models may be used to determine if secondary content depicts a particular individual, was created by a particular individual, and/or the like. The one or more artificial intelligence models may be created by the identity verification system and may be unique to the individual. The models are created using content that corresponds to an individual to train the model. Alternatively, or additionally, the content could be content that is known as not corresponding to the individual. In other words, content that is purported to be of an individual may be identified as not being of that individual. This content can then be used to negatively train the model, meaning it is used as an example of content that purports to be of the individual, but that is actually not of the individual or is fake.

For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model (e.g., a general model, such as a general classification model) that is fine-tuned for the identity verification system, or the artificial intelligence model may be a model that is created and trained from scratch. Since the identity verification system is used in conjunction with determining whether a received secondary content is authentic with respect to the individual, some models that may be utilized by the system are image analysis models, video analysis models, text analysis models, audio analysis models, analysis models, similarity identification models, language models, large language models, entity identification models, input analysis models, filtering models, classification models, body language analysis models, and/or the like. The model may be trained using one or more training datasets.

Additionally, as the model is deployed, it may receive feedback to become more accurate over time. Alternatively, or additionally, the model may utilize inputs provided to the model to learn continually, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model. Alternatively, or additionally, the user can provide additional content that should be used to be further train, retrain, or refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, active learning, transfer learning, weak supervision, data augmentation, weakly supervised learning, and/or the like. Accordingly, the training dataset may include annotated data, unannotated data, and/or the like, or a combination thereof.

Whether the model automatically ingests feedback during deployment or not may be determined by a user, author, and/or entity that has deployed the model. Automatic learning by the model may be useful in some applications, but may be detrimental in other applications. Accordingly, a user may make a determination regarding the trainability of the model during deployment. Regardless of whether the model can be retrained during deployment or is only retrained upon instruction by a user, the feedback or inputs could be stored within a data store and utilized at a later time to train or retrain the model. For example, a user could use the feedback to update a training dataset to train or retrain the model. The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

As previously mentioned, an ensemble of models or multiple models may also be utilized. Some example models that may be utilized are variational autoencoders, generative adversarial networks, recurrent neural networks, convolutional neural networks, deep neural networks, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model. Additionally, the feature sets, vectors, layers, outputs, and/or other characteristics of the model may be chosen by a user based upon the application.

The identity verification system may include different components for carrying out different functions of the system, including different steps to be performed. These components may be hardware components or software components. Some hardware devices or components that may be utilized by the identity verification system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the identity verification system. For example, the identity verification system may include speakers, displays or monitors, haptic output devices, audio output devices, and/or the like.

Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the identity verification system, and/or the like. The identity verification system may also interface with hardware components of a device. For example, instead of the identity verification system including a display, the identity verification system may provide instructions to display content on a display component of a user device that is employing or communicating with the identity verification system.

One software component may include a data storage location or data repository that stores information related to content of an individual, user profiles, historical information, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by user, grouped by content type (e.g., spoken content, written content, image content, video content, etc.), and/or the like. The information stored within the data repository may be indexed or grouped based upon multiple identifiers or other characteristics. Thus, the data repository can allow for filtering and sorting.

Another software component includes one or more profiles that store information related to a user. This profile may include the content that corresponds to the individual, include information related to how to get additional content, and/or the like. The profile may also identify how the artificial intelligence model may behave while deployed. For example, the profile may identify how frequently the model will respond to queries, how many queries a single entity or user can provide before being prevented from providing queries, entities or users that are allowed to query the model, sources of secondary content to be mined by the model, and/or the like. This profile information may be utilized by a guardrail of the AI model in order to respond to queries. The guardrail is a protocol and tool that ensures the AI model operate as intended by the AI model author or owner. The guardrail ensures that the model operates within defined boundaries and principals. The profile may include the information related to the boundaries and principals.

The guardrail could perform an initial determination regarding the authenticity of a secondary content. If the guardrail is unable to make a determination, then the secondary content may be provided, from the guardrail, to the AI model. The guardrail may also perform an initial determination regarding whether a determination of authenticity should be made. In other words, the guardrail may determine that the secondary content should not be verified or authenticated for one reason or another. For example, the guardrail may determine that a single entity is continuously providing queries regarding an authenticity of secondary content, so the guardrail may determine this behavior is indicative of an entity attempting to learn how the AI model makes determinations and may determine that no additional authentications should be made for the entity. As another example, the guardrail may determine that an entity providing a query is not an entity that is authorized to make a query and may, therefore, refuse to authenticate the secondary content that is being provided within the query.

Information within a profile may be identified through manual input, or may be identified by the identity verification system as the system is utilized and inputs are provided to the system. Thus, the identity verification system can monitor inputs provided at both a device and also at external components. Once inputs have been provided (e.g., manual input, audible input, gesture input, etc.), the identity verification system can store this information or settings within a profile. Any of the mentioned profiles, or other profiles, may include additional information that may be useful for the identity verification system and may be entered by a user, may be default values, may be learned by the system over time, and/or the like.

Thus, profiles can be populated with information manually by a user, entities or companies, and/or the like, or can be populated over time as the system learns more about the user, components, images, entities or companies, and/or the like. For example, a user may manually provide input to a user profile and the system can learn preferences about the user over time and populate the user profile with this learned information. Learned information may be information learned based upon direct inputs, for example, a user may be presented with a pop-up window in response to a trigger and provide input to the pop-up window. This input can be then populated into a profile. Learned information may also be information learned based upon indirect inputs. The system can then aggregate this information to learn information over time.

At 301, the identity verification system receives a corpus of content (also referred to simply as content) corresponding to an individual. Receipt of the content may be via any one or more techniques that can be utilized to provide information to a system or source. For example, the content may be provided through a direct provision where the user uploads the content to the identity verification system, may be provided via a link or pointer that provides an indication of where the content can be found (e.g., a link to a data repository, a link to a social media account, a link to an email account, a link to an application or program that stores content, etc.), may be provided by placing the content within a storage location of the identity verification system, and/or any other data receipt or provision technique, or a combination thereof. Content may be located in many different locations, so the provision of the content may be performed in multiple different ways so that the system can access the content.

Content corresponding to an individual refers to content that depicts the individual, content created by the individual, and/or content that has some relationship to the individual. Thus, the corpus of content corresponds to the individual and characteristics of the individual and is, therefore, indicative of authorship characteristics of the individual. The content may be content that corresponds to a characteristic of the individual such as, for example, a speaking style of the individual, mannerisms of the individual, a mood of the individual, a writing style of the individual, body language of the individual, voice inflections of the individual, and/or the like. The content is content that can allow the identity verification system to learn specific characteristics of the individual in order to be able to discern whether media (e.g., images, video, written works, spoken works, etc.) is related to the individual (e.g., depicts the individual, is authored by the individual, etc.). Accordingly, the content can be any type of visual, written, spoken, and/or the like, content that is known to be related to or authentic with respect to the individual. In other words, the content is any type of content that is known to be real with respect to the individual.

The content is utilized to train an individual artificial intelligence model that is able to discern or verify whether other content is authentic with respect to the individual. Therefore, the content that is received at 301 is content controlled by the individual. This may mean that the individual themselves provides or controls access to the content, may mean that a user who is authorized by the individual provides or controls access to the content, or a combination thereof. Providing or controlling access to the content refers to how the content is provided to the identity verification system. In other words, the individual controls the content that is received at 301.

The content that is received at 301 may be content that is not public information and may be content that is selected by the individual as particularly corresponding to the individual. In other words, in order to best train the model, the individual may provide content which the individual feels depicts particular characteristics of the individual well. The content can also be public information, for example, a social media account, a particular online website, public videos, and/or the like. However, at least part of the content may be content that is not publicly available so the model is able to be trained on information that another model could be trained upon. In other words, while the individual AI model could be trained using public content, the content is selected by the individual as being the most representative of the individual and likely has access to more personal documents that are not publicly available to make the AI model more accurate. The important part of this content is that it is known to be authentic content with respect to the individual, meaning it is an authentic depiction of the individual, it is an authentic writing of the individual, and/or the like.

The content may also be content that is known to be not of or depicting the individual. This can be referred to as known negative content. Known negative content can be used to negatively train the model with content that is known as not being authentic to the user or, stated differently, known to be fake content with respect to the individual. Using known negative content, in addition to the authentic content, allows the system to not only learn actual characteristics of the individual, but also learn what characteristics do not correspond to the individual, which may assist the model with more accurate discernment of content with respect to the individual.

The content may also include content that is related to different environments, for example, different locations, different people with or around the individual, different formalities with respect to writings (e.g., social media sites, professional papers or writings, friendly papers or writings, etc.), different formalities with respect to events (e.g., after work settings, professional settings, friendly settings, formal settings, etc.), and/or the like. Since individuals may act differently in different environments, having content related to the different environments may allow the model to be more accurate. When the model is utilized to verify an authenticity of secondary content, the environment of the secondary content may be considered and the model can make a determination regarding the authenticity at least partially based upon the environment.

Additionally, since the individual may be in different locations, different information related to the environments may also be included so that the model can not only learn about the individual, but can also learn about environments to assist in authenticating secondary content. In other words, in authenticating secondary content, the system may not only use information related to the individual to authenticate the secondary content, but may also use information related to the environment to authenticate the environment which assists in verifying an authenticity of the secondary content itself. For example, if an environment at a particular time generally includes the sounds of steel drums, secondary content that is purported to be of the individual at that location at that time and that does not include the sounds of steel drums may be less likely to be authentic with respect to the environment and may, therefore, be less likely to be authentic with respect to the individual. Accordingly, the content may include background sounds of known locations, biometrics that drive assumptions of specific outputs, and/or the like.

At 302, the identity verification system creates an individual artificial intelligence model for the individual from the corpus of content received at 301. In other words, the identity verification system creates an individual artificial intelligence model that is trained using the corpus of content and that is configured to be used to verify authorship of secondary content that is separate from the corpus and is purported as being authored by individual. Thus, the trained the individual AI model will be able to be deployed to determine an authenticity of secondary content. To train the individual AI model, the content may be included in a training dataset that is then used to train the model. Thus, the training dataset may include not only content that is real, or authentic with respect to the individual, but may also include content that is purported to be of the individual but is identified as not actually being of the individual (i.e., known negative content or fake content).

Not only does the identity verification system create the individual AI model, but it also updates the model over time as new content is received at the identity verification system. In other words, new content can be received at 301, even after or during deployment of the individual AI model, that can be used to retrain or update the individual AI model. Accordingly, the individual artificial intelligence model can be updated by receiving a supplemental corpus of content at the identity verification system and further training the individual artificial intelligence model using the supplemental corpus of content. Supplemental corpuses of content can be used to retrain the model, meaning the original corpus is effectively overwritten, or can be used to further train the model, meaning the supplemental corpus can be used to train the model in addition to the original corpus. The ability to train the model using a supplemental corpus is particularly useful since individuals change over time, for example, as individuals age, as individuals learn new things, as individuals change mannerisms, as individuals change a frequenting of environments, and/or the like. Thus, the described system allows the individual AI model to age and change as the individual themselves age and change.

At 303, the identity verification system determines if a received secondary content is authentic with respect to the individual. To determine if a received secondary content is authentic, the secondary content may be received at the individual AI model. To receive the secondary content, a user may query the AI model and include the secondary content within the query. For example, a user may access a graphical user interface associated with the AI model and provide input to an input field in the graphical user interface requesting a verification or validation of an authenticity of the secondary content. In other words, the secondary content may be received via a query to the individual artificial intelligence model requesting a determination of whether the secondary content is authentic with respect to the individual.

In order to prevent entities from identifying what factors are utilized to determining an authenticity of the secondary content (or for other reasons), the individual AI model may only make determinations responsive to determining that a query corresponding to the received secondary content is authorized. Authorized queries may be those queries received by authorized individuals (e.g., specific individuals, specific entities to which individuals belong, etc.), those queries which do not run afoul of settings of the identity verification system (e.g., too many queries within a particular time frame, too many queries from a particular entity or user, queries being received from a particular location, etc.), and/or the like. These determinations can be made using the guardrail of the individual AI model.

The identity verification system, in addition to allowing queries, may also mine secondary sources to authenticate secondary content. Thus, the received secondary content may include content that is mined by the system. When mining the secondary content, the system may be set to mine particular secondary sources types (e.g., social media sites, news sites, video sharing sites, etc.), may be set to mine particular secondary sources (e.g., a particular website, a particular social media site, etc.), may be set to mine particular content types (e.g., videos, images, writings, speeches, etc.), and/or the like. The secondary sources that are mined may be set by the individual, may be default settings, may be learned over time, may be based upon how often fake secondary content is found on that secondary source, and/or the like.

Regardless of whether the secondary content is received via a query or is mined by the system, the system may determine whether the secondary content is authentic. Determining whether secondary content is authentic with respect to the individual means that the identity verification system, and, specifically, the individual AI model, is determining if the secondary content is real, meaning that it really depicts the individual, that it really was authored by the individual, that it really was said by the individual, and/or the like. To make the determination, the AI model ingests the secondary content (assuming it is passed to the AI model past the guardrail), analyzes the secondary content based upon the training of the AI model, and then provides an output regarding the authenticity of the secondary content.

In addition to determining an authenticity of the secondary content, the system may identify a confidence value for the determining. The individual AI model may not be able to determine with an absolute certainty whether the secondary content is authentic or not with respect to the individual. Thus, the AI model may determine a likeliness value, or confidence value, regarding the authenticity of the secondary content. For example, the AI model may determine that a piece of secondary content is 60% likely to be authentic. This likeliness value of 60% correlates to the confidence score or value of the AI model in making the authenticity prediction. In other words, an AI model can make a prediction and determine how confident the model is with the prediction. This confidence correlates to a confidence score or value, which can then be output as an authenticity likeliness value.

If, at 303, the system determines that the secondary content is not authentic with respect to the individual, the identity verification system may provide an output indicating the secondary content is not of the individual at 305. The output may simply be that the content has been identified as not authentic with respect to the individual. If, on the other hand, the system determines, at 303, that the secondary content is authentic with respect to the individual, the identity verification system may provide an output indicating the secondary content is of the individual at 304. In other words, the system may indicate that the secondary content is authentic with respect to the individual. This output may simply be that the content has been identified as authentic with respect to the individual.

Regardless of whether the secondary content is determined to be authentic or not authentic, the output may be similar, except that it is either authentic or not authentic. The output may be a pop-up notification, may be a responsive output in a graphical user interface of the identity verification system, may include watermarking the secondary content, may include tagging the secondary content, and/or the like. Since the output is a determination of the authenticity, the output format may include the authenticity determination. For example, if the output is tagging the secondary content, then the output format may include tagging the secondary content with an authentication tag based upon the determination. If the system also created or determined an authenticity likeliness value, the output may also include this authenticity value. In other words, and for example, the output from the system may indicate that the system is 60% confident that the secondary content is authentic or that the secondary content has a 60% likeliness of being authentic. The output may also include marking the secondary content as being verified by the identity verification system, whether it has been verified as authentic or verified as not authentic.

Not only can the described system be utilized with respect to authenticating secondary content with respect to individual, but it can also be utilized for authenticating the individual for other purposes. For example, since the individual artificial intelligence model can authenticate the individual, the model could also be used for secure authentication of personal assets of the individual. As an example, if an individual had a safe with a camera and microphone, when an individual attempted to access the safe, the safe could utilize the individual AI model to authenticate any inputs received as belonging to the actual individual or not. This could extend access controls beyond fingerprinting or biometrics for security and authentication into access control based upon mood, body language, voice, inflection, and/or any other data that identify an individual as being unique as compared to another individual.

As an overall, non-limiting example a celebrity may provide access to the identity verification system to personal documents, personal videos, personal images, and/or other content that is known to be of the individual. From this content, the identity verification system can create an individual artificial intelligence model that is unique to the individual. The individual AI model is trained on the known authentic content and may also be trained on known negative content. A news agency who wants to verify whether a video purported to be of the individual can access the individual AI model in order to query the model by providing the video and requesting a verification of the video. The trained AI model can analyze the video based upon the training of the model and make a determination regarding whether the video is authentic with respect to the individual. In other words, the trained AI model can determine whether the video is real or fake. The trained AI model can then provide an output indicating the authenticity of the video. The trained AI model can also, or alternatively, identify a level of confidence with respect to the authenticity of the video.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, at an identity verification system, a corpus of content corresponding to an individual, wherein the corpus of content is indicative of authorship characteristics of the individual;
creating, using the identity verification system, an individual artificial intelligence model that is trained using the corpus of content and that is configured to be used to verify authorship of secondary content that is separate from the corpus and purported as being authored by the individual; and
determining, using the individual artificial intelligence model, whether a received secondary content is authentic with respect to the individual.

2. The method of claim 1, further comprising updating the individual artificial intelligence model by receiving a supplemental corpus of content at the identity verification system and further training the individual artificial intelligence model using the supplemental corpus of content.

3. The method of claim 1, wherein the creating comprises training the individual artificial intelligence model utilizing secondary content that is purported to be of the individual and is identified as not being of the individual.

4. The method of claim 1, comprising tagging the received secondary content with an authentication tag based upon the determining.

5. The method of claim 1, wherein the determining comprises identifying a confidence value for the determining.

6. The method of claim 1, wherein the secondary content is received via a query to the individual artificial intelligence model requesting a determination of whether the secondary content is authentic with respect to the individual.

7. The method of claim 1, wherein the individual artificial intelligence model comprises a guardrail that performs an initial iteration of the determining.

8. The method of claim 1, wherein the determining comprises mining at least one secondary source for the received secondary content.

9. The method of claim 1, wherein the determining is responsive to determining that a query corresponding to the received secondary content is authorized.

10. The method of claim 1, wherein the content comprises content corresponding to at least one of: a speaking style of the individual, mannerisms of the individual, a mood of the individual, and a writing style of the individual.

11. A system, the system comprising:
a processor;
a memory device that stores instructions that, when executed by the processor, causes the system to:
receive, at an identity verification system, a corpus of content corresponding to an individual, wherein the corpus of content is indicative of authorship characteristics of the individual;
create, using the identity verification system, an individual artificial intelligence model that is trained using the corpus of content and that is configured to be used to verify authorship of secondary content that is separate from the corpus and purported as being authored by the individual; and
determine, using the individual artificial intelligence model, whether a received secondary content is authentic with respect to the individual.

12. The system of claim 11, further comprising updating the individual artificial intelligence model by receiving a supplemental corpus of content at the identity verification system and further training the individual artificial intelligence model using the supplemental corpus of content.

13. The system of claim 11, wherein the creating comprises training the individual artificial intelligence model utilizing secondary content that is purported to be of the individual and is identified as not being of the individual.

14. The system of claim 11, comprising tagging the received secondary content with an authentication tag based upon the determining.

15. The system of claim 11, wherein the determining comprises identifying a confidence value for the determining.

16. The system of claim 11, wherein the secondary content is received via a query to the individual artificial intelligence model requesting a determination of whether the secondary content is authentic with respect to the individual.

17. The system of claim 11, wherein the individual artificial intelligence model comprises a guardrail that performs an initial iteration of the determining.

18. The system of claim 11, wherein the determining comprises mining at least one secondary source for the received secondary content.

19. The system of claim 11, wherein the determining is responsive to determining that a query corresponding to the received secondary content is authorized.

20. A product, the product comprising:
a computer-readable storage device that stores executable code that, when executed by a processor, causes the product to:
receive, at an identity verification system, a corpus of content corresponding to an individual, wherein the corpus of content is indicative of authorship characteristics of the individual;
create, using the identity verification system, an individual artificial intelligence model that is trained using the corpus of content and that is configured to be used to verify authorship of secondary content that is separate from the corpus and purported as being authored by the individual; and
determine, using the individual artificial intelligence model, whether a received secondary content is authentic with respect to the individual.
